(19) United States
(12) Patent Application Publication
(10) Pub. No.: US 2011/0079662 A1
(43) Pub. Date: Apr. 7, 2011

(54) Driving Device of a Sprinkler and Swinging Sprinkler with the Driving Device

(76) Inventors: Po-Hsiung Wang, Chu-Nan Chen (TW); Tzu-Meng Wang, Chu-Nan Chen (TW)

(21) Appl. No.: 12/614,484

(22) Filed: Nov. 9, 2009

(30) Foreign Application Priority Data
Oct. 2, 2009 (TW) 098133476

(51) Int. Cl. B05B 3/04

(52) U.S. Cl. 239/240

(57) ABSTRACT

A driving device of a sprinkler has a housing, a diversion assembly and a gear set mounted in the housing, a switch assembly mounted on a front open end of the housing and a nozzle mounted through the switch assembly and connected to the diversion assembly. In the switch assembly, as an inner ring is pushed, a resilient strip and a switch valve swing so the gear set drives the nozzle in different directions. Since switch rings securely engage the inner ring, when a limit of the nozzle collides with a stop of one of the switch rings, the switch ring and the inner ring immediately rotate to push a switch rod and to switch rotating directions of the nozzle. Therefore, the switch rings are not damaged easily for improved durability.

### BACKGROUND OF THE INVENTION

1. Field of the Invention

The present invention relates to a driving device of a sprinkler and a swinging sprinkler with the driving device, especially to driving device that allows the sprinkler to rotate for improved water distribution.

2. Description of the Prior Art(s)

Sprinklers are usually mounted in meadows, fields or lawns for irrigation. A conventional sprinkler has a pipe and a gear set driving the pipe. However, since the pipe has a large moment of inertia, the gear set that drives the pipe to switch rotating directions is under great strain and breaks easily. Therefore, another conventional sprinkler such as a DUAL-AXIS ROTATING SPRINKLER (U.S. Pat. No. 7,427,038) has a rotating assembly that does not rotate itself and rotates a nozzle to prevent gears of the rotating assembly from being damaged and to extend an operating life of the sprinkler. The rotating assembly has a switch disk, two stops movably clamped on an edge of the switch disk, a connecting disk and a limit mounted on the connecting disk and protruding between the stops. The nozzle is mounted on and rotates together with the connecting disk relative to the switch disk and switches rotating directions when the limit of the switch disk alternatively collides with the stops of the connecting disk.

However, since the stops are only clamped on the switch disk and are not securely connected to the switch disk, the switch disk does not move immediately when the limit collides with the stops. Moreover, as the limit of the connecting disk continuously applies force to the stops of the switch disk, the stops dispart from the switch disk easily.

To overcome the shortcomings, the present invention provides a driving device of a sprinkler and a swinging sprinkler with the driving device to mitigate or obviate the aforementioned problems.

### SUMMARY OF THE INVENTION

The main objective of the present invention is to provide a driving device of a sprinkler and a swinging sprinkler with the driving device.

The driving device has a housing, a diversion assembly and a gear set mounted in the housing, a switch assembly mounted on a front open end of the housing and a nozzle mounted through the switch assembly and connected to the diversion assembly.

In the switch assembly, as an inner ring is pushed, a resilient strip and a switch valve swing so the gear set drives the nozzle in different directions. Since switch rings securely engage the inner ring, when a limit of the nozzle collides with a stop of one of the switch rings, the switch ring and the inner ring immediately rotate to push a switch rod and to switch rotating directions of the nozzle. Therefore, the switch rings are not damaged easily for improved durability.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a driving device of a sprinkler in accordance with the present invention;

FIG. 2 is an enlarged exploded front perspective view of the driving device in FIG. 1;

FIG. 3 is an enlarged exploded rear perspective view of the driving device in FIG. 1;

FIG. 4 is an enlarged perspective view of the driving device in FIG. 1, a base shown in phantom lines;

FIG. 5 is another enlarged perspective view of the driving device in FIG. 1, the base shown in phantom lines;

FIG. 6 is another enlarged exploded front perspective view of the driving device in FIG. 1;

FIG. 7 is another enlarged exploded rear perspective view of the driving device in FIG. 1;

FIG. 8 is a perspective view of a first embodiment of a swinging sprinkler with the driving device in FIG. 1 in accordance with the present invention;

FIG. 9 is a partially exploded front perspective view of the swinging sprinkler in FIG. 8;

FIG. 10 is a partially exploded rear perspective view of the swinging sprinkler in FIG. 8;

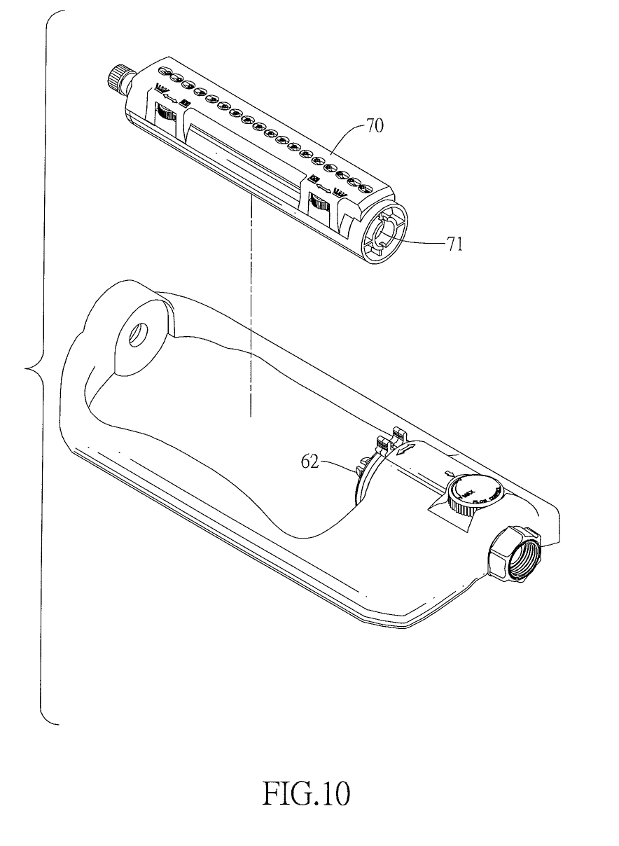

FIG. 11 is a perspective view of a second embodiment of a swinging sprinkler with the driving device in FIG. 1 in accordance with the present invention;

FIG. 12 is a partially exploded front perspective view of the swinging sprinkler in FIG. 11;

FIG. 13 is a partially exploded rear perspective view of the swinging sprinkler in FIG. 11;

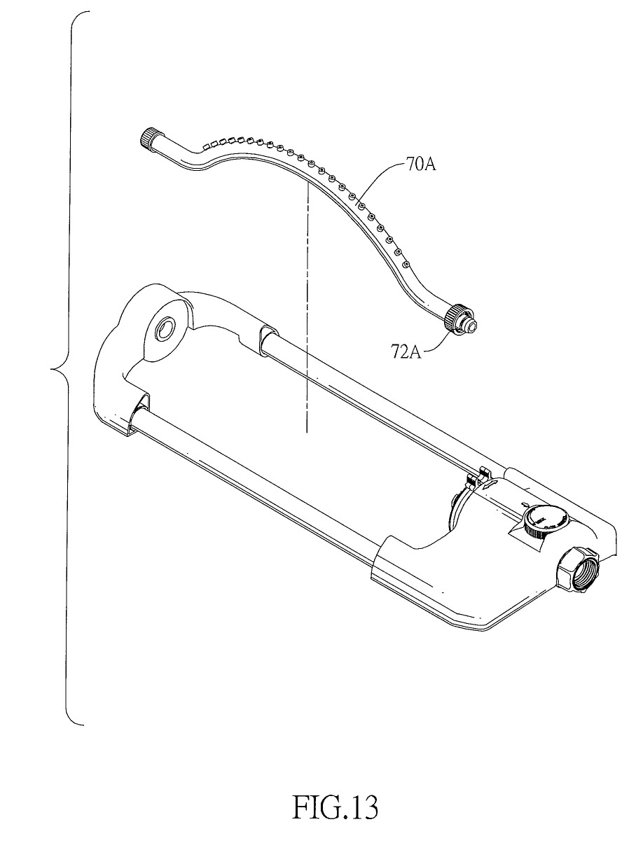

FIG. 14 is a partial operational side view of the driving device in FIG. 1; and

FIG. 15 is another partial operational side view of the driving device in FIG. 1.

### DETAILED DESCRIPTION OF THE PREFERRED EMBODIMENTS

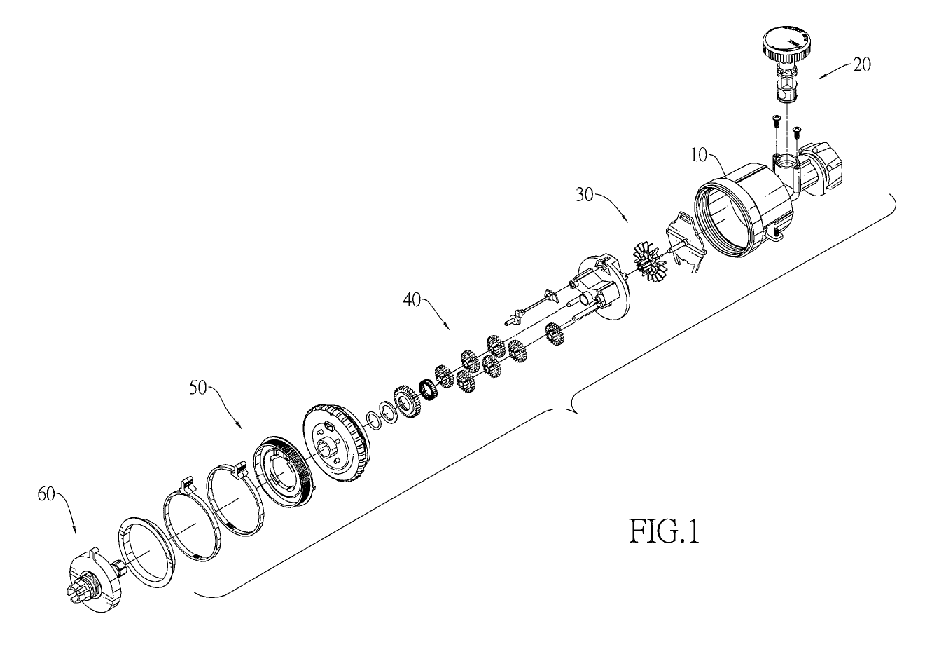

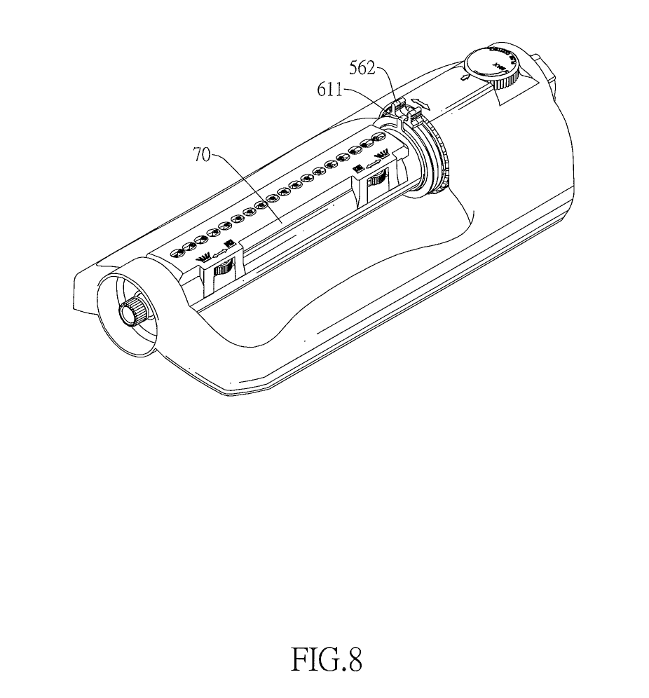

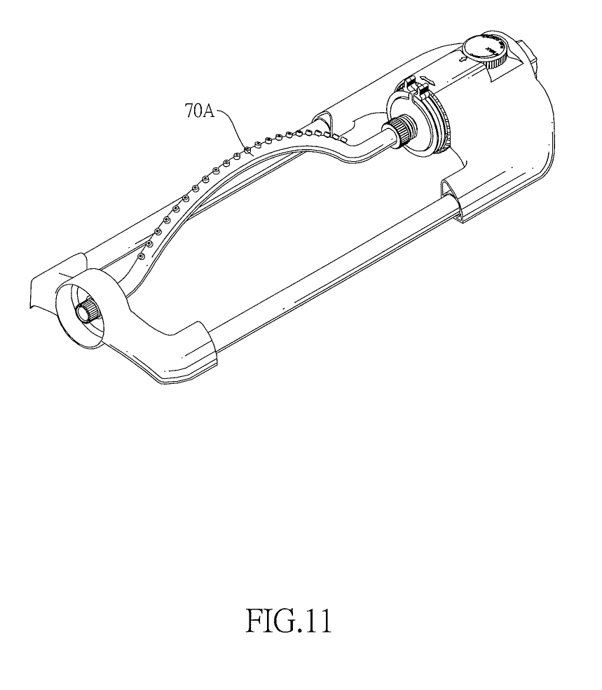

With reference to FIGS. 1, 8 and 11, a swinging sprinkler in accordance with the present invention comprises a frame, a pipe (70, 70A) and a driving device in accordance with the present invention. The pipe (70, 70A) is rotatably mounted in the frame and has a connecting end. The connecting end of the pipe (70, 70A) may be a socket (71) or may have an internal thread (72A).

The driving device is mounted in the frame and comprises a housing (10), an adjusting assembly (20), a diversion assembly (30), a gear set (40), a switch assembly (50) and a nozzle (60, 60A).

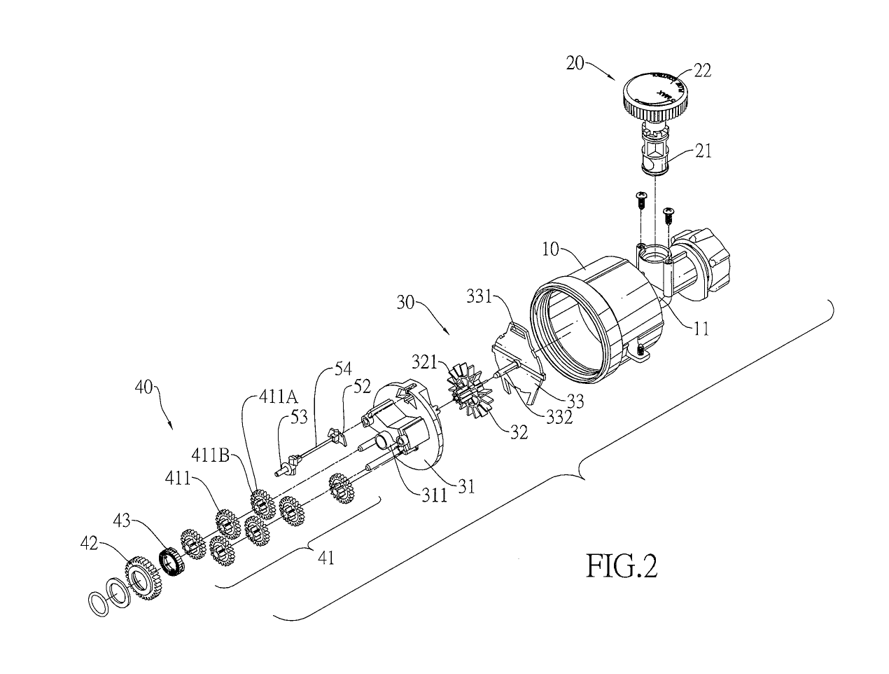

With further reference to FIG. 2, the housing (10) is tubular and has an inlet tube (11). The inlet tube (11) is attached to a rear open end of the housing (10).

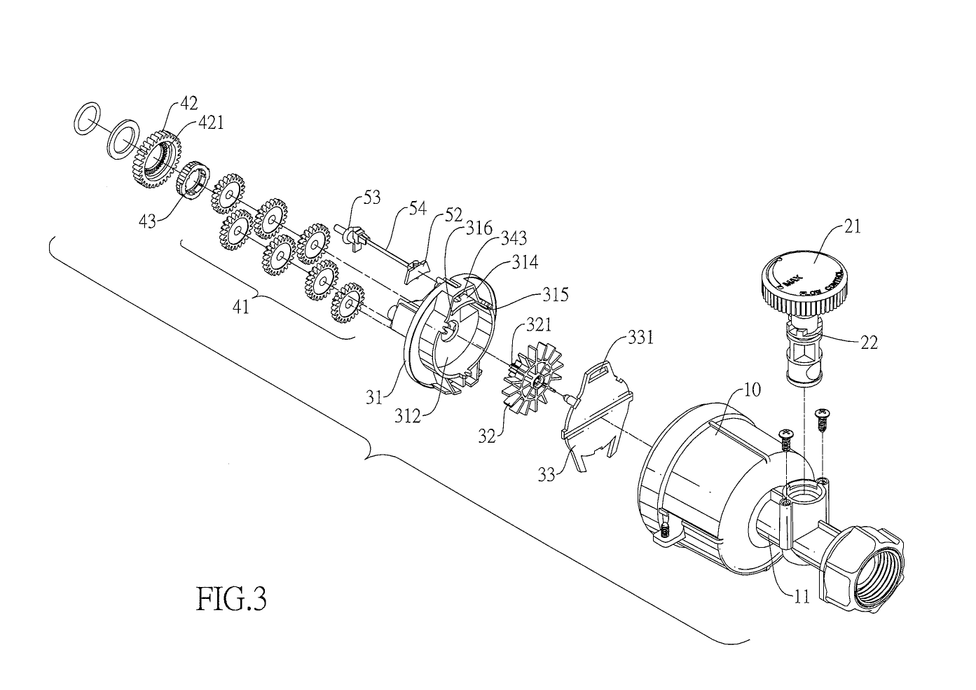

With further to FIG. 3, the adjusting assembly (20) is connected to the inlet tube (11) and has a switch valve (21) and a knob (22). The switch valve (21) is mounted through the inlet tube (11) and selectively seals the inlet tube (11). The knob (22) is attached to an outer end of the switch valve (21). When the knob (22) is turned, the switch valve (21) turns simultaneously to adjust water flow through the inlet tube (11) and the switch valve (21).

The diversion assembly (30) is mounted in the housing (10) and has a base (31), an impeller (32) and a rear cover (33).

The base (31) has a connecting tube (311), a containing chamber (312), an inlet chamber (313), an inner wall, a divider (314), a first gap (315) and a second gap (316). The connecting tube (311) protrudes from a front surface of the base (31). The containing chamber (312) is formed in a rear surface of the base (31) and corresponds to and communicates with the connecting tube (311). The inlet chamber (313) is formed in the rear surface of the base (31) adjacent to the containing chamber (312). The inner wall is defined around the containing chamber (312) and the inlet chamber (313). The divider (314) is formed between the containing chamber (312) and the inlet chamber (313) and has two ends. The first gap (315) and the second gap (316) are respectively defined between the ends of the divider (314) and the inner wall of the base (31) and connect the containing chamber (312) with the inlet chamber (313).

The impeller (32) is rotatably mounted in the containing chamber (312) of the base (31) and has an actuating gear (321). The actuating gear (321) is coaxially formed on a front surface of the impeller (32), is mounted through the connecting tube (311) and protrudes to the front surface of the base (31).

The rear cover (33) is mounted on the rear surface of the base (31), covers the containing chamber (312) and has a pivot rod (332) and an inlet hole (331). The pivot rod (332) protrudes from a front surface of the rear cover (33) and extends through the impeller (32) to rotatably mount the impeller (32) in the base (31). The inlet hole (331) is formed through the rear cover (33) and corresponds to and communicates with the inlet chamber (313) of the base (31).

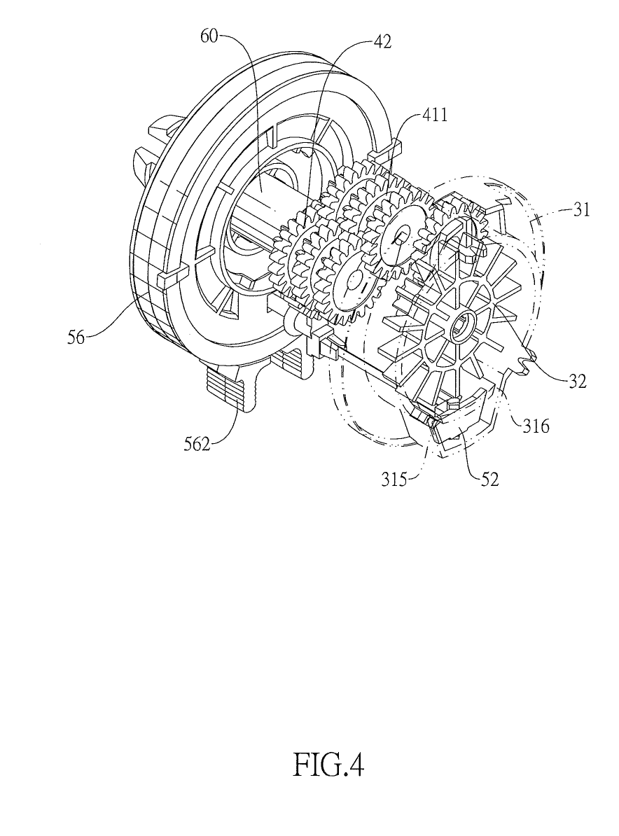

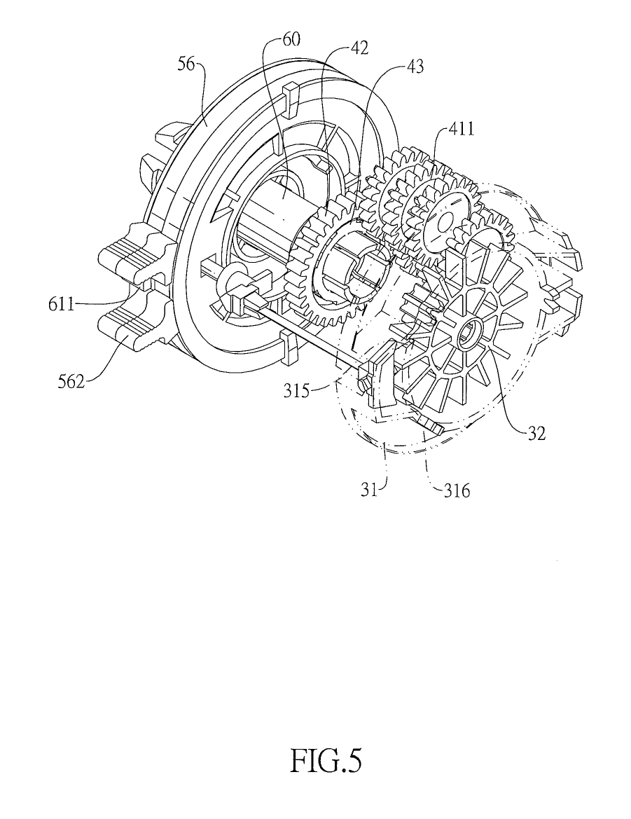

With further reference to FIGS. 4 and 5, the gear set (40) is mounted in the housing (10) and on the front surface of the base (31) and has a transmission assembly (41), a driven gear (42) and a ratchet gear (43).

The transmission assembly (41) is connected to the actuating gear (321) of the impeller (32) and has multiple transmission gears (411). The transmission gears (411) engage in sequence. Each transmission gear (411) has a driven gear (411A) and a transfer gear (411B). The driven gear (411A) of a final transmission gear engages the actuating gear (321) of the impeller (32). The transfer gear (411B) is disposed coaxially with and is formed smaller than the driven gear (411A) and engages the driven gear (411A) of a hinder transmission gear (411).

The driven gear (42) is connected to the transmission assembly (41), engages an initial transmission gear (411) of the transmission assembly (41) and has multiple ratchet teeth (421). The ratchet teeth (421) are formed in and around a rear surface of the driven gear (42).

The ratchet gear (43) is mounted on the rear surface of the driven gear (42) and engages the ratchet teeth (421) of the driven gear (42).

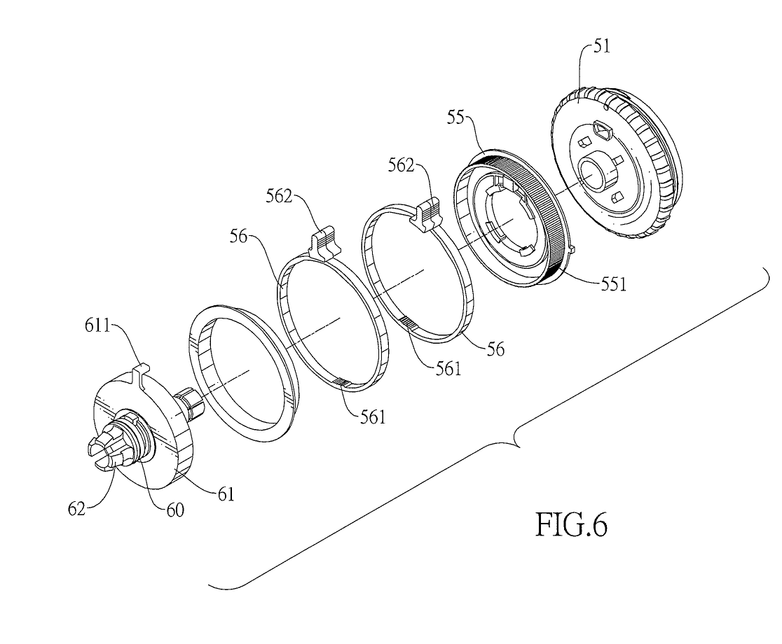

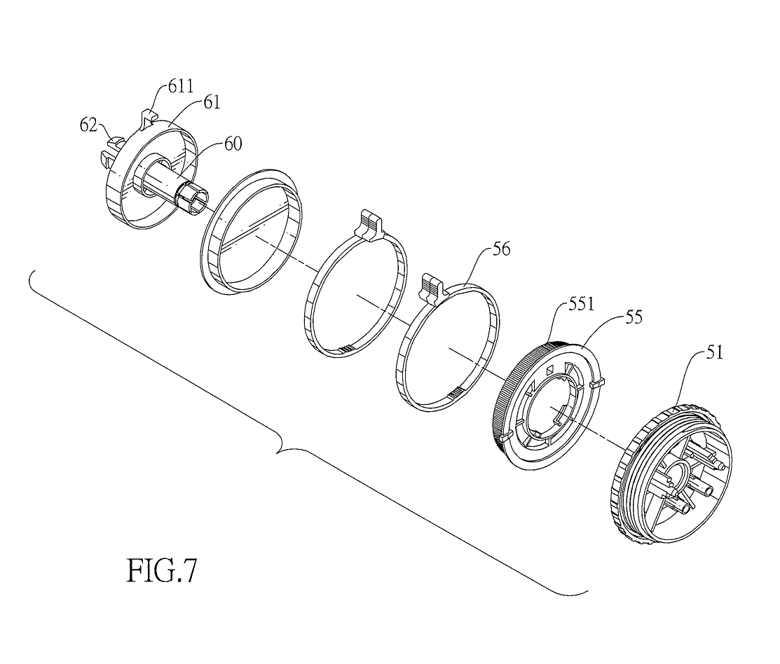

With further reference to FIGS. 6 and 7, the switch assembly (50) has a front cover (51), a switch valve (52), a switch rod (53), a resilient strip (54), an inner ring (55) and two switch rings (56). The front cover (51) is mounted on and covers a front open end of the housing (10).

The switch valve (52) is pivotally mounted on the front surface of the base (31) and alternatively seals the first and second gaps (315, 316) of the base (31). The switch rod (53) is mounted through the front cover (51). The resilient strip (54) is mounted between and is connected to the switch valve (52) and the switch rod (53). As the switch rod (53) is pushed, the resilient strip (54) is bent toward different directions and the switch valve (52) alternatively seals the first and second gaps (315, 316) of the base (31).

The inner ring (55) is mounted on a front surface of the front cover (51), is securely connected to the switch rod (53) and has multiple positioning teeth (551). The positioning teeth (551) are formed in and around an outer surface of the inner ring (55). The switch rings (56) are mounted around the inner ring (55). Each switch ring (56) has at least one toothed part (561) and a stop (562). The at least one toothed part (561) is formed in an inner surface of the switch ring (56) and engages the positioning teeth (551) of the inner ring (55). The stop (562) protrudes radially from an outer surface of the switch ring (56). As the stops (562) are pushed and the switch rings (56) are turned relative to the inner ring (55), relative positions between the stops (562) are adjusted.

The nozzle (60, 60A) is mounted through the inner ring (55) and the front cover (51), is connected to the connecting tube (311) of the base (31) and has a rear end, a front end, a disk (61) and a limit (611).

The rear end of the nozzle (60) is connected to the ratchet gear (43).

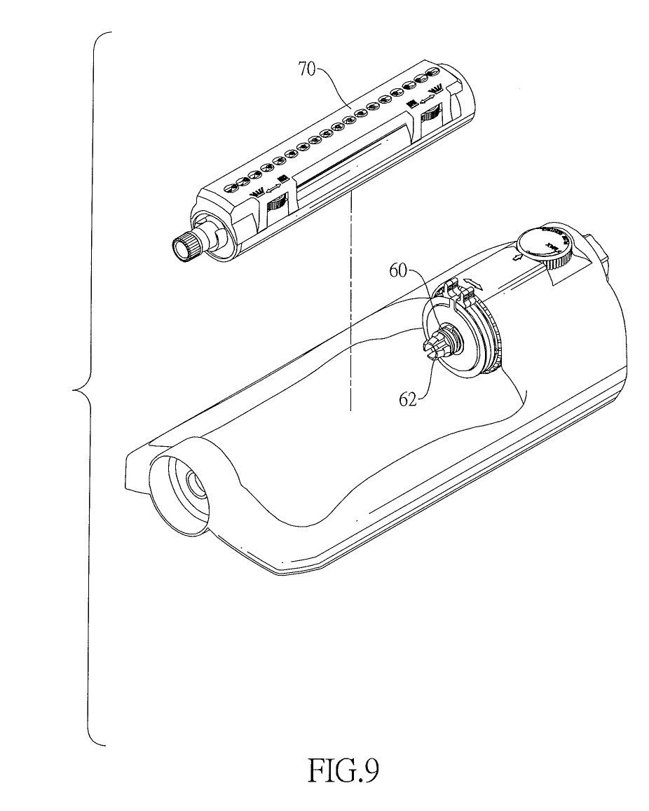

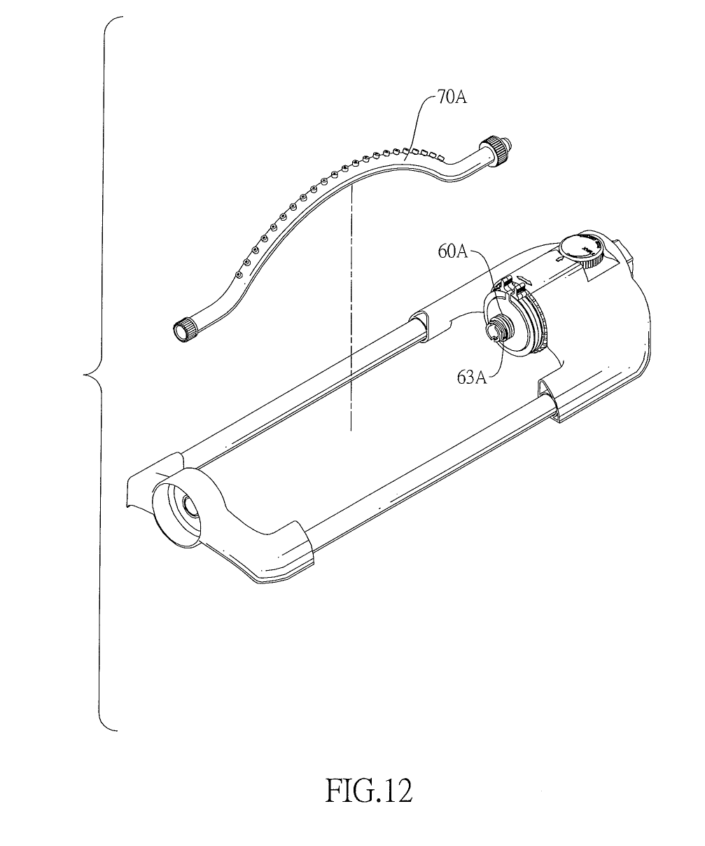

With further reference to FIGS. 9 and 12, the front end of the nozzle (60, 60A) is connected to the connecting end of the pipe (70, 70A) and may be a split plug (62) or may have an external thread (63A). The split plug (62) is held in the socket (71) of the pipe (70). The external thread (63A) engages the internal thread (72A) of the pipe (70A).

The disk (61) is formed around an outer surface of the nozzle (60, 60A). The limit (611) is formed on a peripheral edge of the disk (61) and protrudes between and alternatively abuts the stops (562) of the switch rings (56).

Water flows through the switch valve (21) and the inlet tube (11) and then into the housing (10) and then further flows through the inlet hole (331) of the rear cover (33) alternatively through the first and second gaps (315, 316) of the base (31), into the connecting tube (311) and the nozzle (60, 60A) and then exits the pipe (70, 70A).

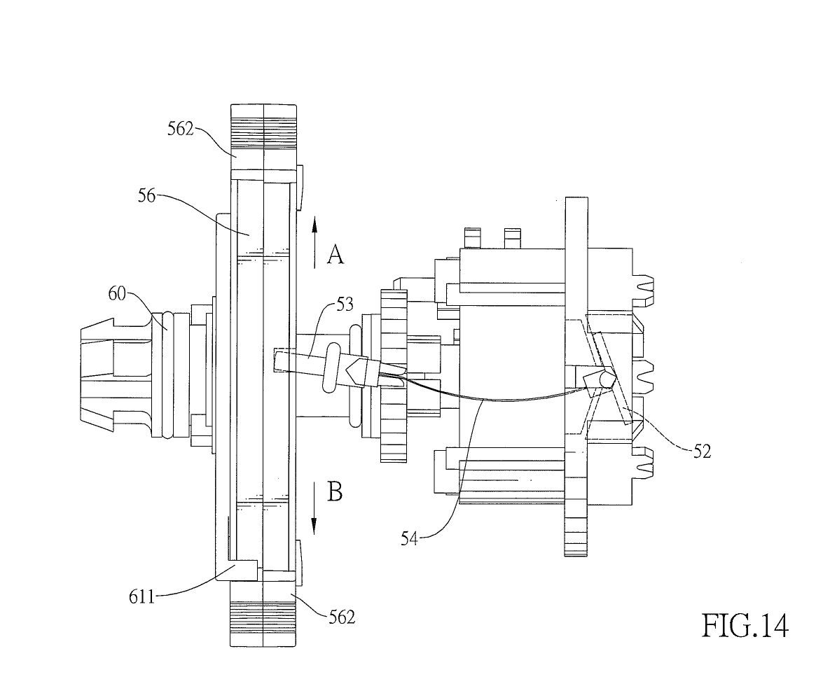

With reference to FIGS. 4, 5, 8 and 14, the switch rod (53) alternatively swings toward a direction A and a direction B. When the switch rod (53) swings toward the direction A and bends the resilient strip (54) so the switch valve (52) seals the second gap (316) of the base (31), the water flows through the first gap (315) and into the containing chamber (312) of the base (31). Then the water forces the impeller (32) to rotate in the direction A and consequently the actuating gear (321) of the impeller (32) drives the transmission assembly (41) and the driven gear (42). Furthermore, the ratchet gear (43) is pushed by the water and is securely attached to the driven gear (42) to ensure that the driven gear (42) further drives the ratchet gear (43). While the transmission assembly (41) has an odd number of transmission gears (411), as the ratchet gear (43) drives the nozzle (60, 60A) in the direction A, the pipe (70, 70A) also rotates in the direction A.

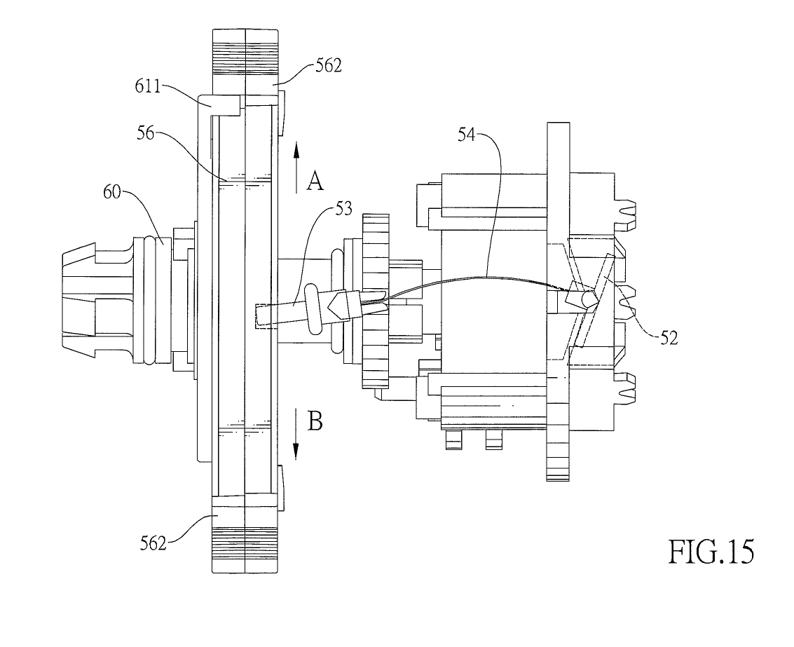

With reference to FIGS. 4, 5, 8 and 15, the nozzle (60, 60A) rotates until the limit (611) of the nozzle (60, 60A) collides with the stop (562) of one of the switch rings (56) and the switch ring (56) and the inner ring (55) then swings in the direction B, the switch valve (52) seals the first gap (315) of the base (31). Therefore, the water flows through the second gap (316) of the base (31) and into the containing chamber (312) of the base (31) and then forces the impeller (32), the nozzle (60, 60A) and the pipe (70, 70A) to rotate in the direction B.

The driving device of the sprinkler as described has the following advantages. The toothed parts (561) of the switch rings (56) engage the positioning teeth (551) of the inner ring (55) to securely connect the switch rings (56) to the inner ring (55). Therefore, when the limit (611) of the nozzle (60, 60A) collides with the stop (562) of one of the switch rings (56), the switch ring (56) and the inner ring (55) immediately rotate slightly to push the switch rod (53) and to switch rotating direction of the nozzle (60, 60A). The gear set (40) that drives the nozzle (60, 60A) and the pipe (70, 70A) has simplified elements that have to rotate, reducing a moment of inertia of the pipe (70, 70A) so prevents elements of the gear set (40) from being damaged.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A driving device of a sprinkler comprising a tubular housing having an inlet tube attached to a rear open end of the housing;
a diversion assembly mounted in the housing and having
a base having
a connecting tube protruding from a front surface of the base;
a containing chamber formed in a rear surface of the base and corresponding to and communicating with the connecting tube;
an inlet chamber formed in the rear surface of the base adjacent to the containing chamber;
an inner wall defined around the containing chamber and the inlet chamber;
a divider formed between the containing chamber and the inlet chamber and having two ends; and
a first gap and a second gap respectively defined between the ends of the divider and the inner wall of the base and connecting the containing chamber with the inlet chamber;
an impeller rotatably mounted in the containing chamber of the base and having an actuating gear coaxially formed on a front surface of the impeller, mounted through the connecting tube and protruding to the front surface of the base; and
a rear cover mounted on the rear surface of the base, covering the containing chamber and having an inlet hole formed through the rear cover and corresponding to and communicating with the inlet chamber of the base;
a gear set mounted in the housing and on the front surface of the base and having
a transmission assembly connected to the actuating gear of the impeller;
a driven gear connected to the transmission assembly and having multiple ratchet teeth formed in and around a rear surface of the driven gear; and
a ratchet gear mounted on the rear surface of the driven gear and engaging the ratchet teeth of the driven gear;
a switch assembly having
a front cover mounted on and covering a front open end of the housing;
a switch valve pivotally mounted on the front surface of the base and alternatively sealing the first and second gaps of the base;
a switch rod mounted through the front cover;
a resilient strip mounted between and connected to the switch valve and the switch rod;
an inner ring mounted on a front surface of the front cover, securely connected to the switch rod and having multiple positioning teeth formed in and around an outer surface of the inner ring; and
two switch rings mounted around the inner ring, and each switch ring having
at least one toothed part formed in an inner surface of the switch ring and engaging the positioning teeth of the inner ring; and
a stop protruding radially from an outer surface of the switch ring; and
a nozzle mounted through the inner ring and the front cover, connected to the connecting tube of the base and having
a rear end connected to the ratchet gear;
a disk formed around an outer surface of the nozzle; and
a limit formed on a peripheral edge of the disk and protruding between and alternatively abutting the stops of the switch rings.

2. The driving device as claimed in claim 1, wherein the transmission assembly of the gear set further has multiple transmission gears engaging in sequence.

3. The driving device as claimed in claim 2, wherein each transmission gear of the transmission assembly further has
a driven gear; and
a transfer gear disposed coaxially with and formed smaller than the driven gear and engaging the driven gear of a hinder transmission gear.

4. The driving device as claimed in claim 1 further comprising an adjusting assembly connected to the inlet tube and having
a switch valve mounted through the inlet tube and selectively sealing the inlet tube; and
a knob attached to an outer end of the switch valve.

5. The driving device as claimed in claim 2 further comprising an adjusting assembly connected to the inlet tube and having
a switch valve mounted through the inlet tube and selectively sealing the inlet tube; and
a knob attached to an outer end of the switch valve.

6. The driving device as claimed in claim 3 further comprising an adjusting assembly connected to the inlet tube and having
a switch valve mounted through the inlet tube and selectively sealing the inlet tube; and
a knob attached to an outer end of the switch valve.

7. The driving device as claimed in claim 1, wherein the rear cover of the diversion assembly further has a pivot rod protruding from a front surface of the rear cover and extending through the impeller.

8. The driving device as claimed in claim 2, wherein the rear cover of the diversion assembly further has a pivot rod protruding from a front surface of the rear cover and extending through the impeller.

9. The driving device as claimed in claim 3, wherein the rear cover of the diversion assembly further has a pivot rod protruding from a front surface of the rear cover and extending through the impeller.

10. The driving device as claimed in claim 4, wherein the rear cover of the diversion assembly further has a pivot rod protruding from a front surface of the rear cover and extending through the impeller.

11. The driving device as claimed in claim 5, wherein the rear cover of the diversion assembly further has a pivot rod protruding from a front surface of the rear cover and extending through the impeller.

12. The driving device as claimed in claim 6, wherein the rear cover of the diversion assembly further has a pivot rod protruding from a front surface of the rear cover and extending through the impeller.

13. A swinging sprinkler with a driving device as claimed in claim 1 comprising
a frame;
a pipe rotatably mounted in the frame and has a connecting end; and
a front end of the nozzle is connected to the connecting end of the pipe.

14. The swinging sprinkler with the driving device as claimed in claim 13, wherein
the connecting end of the pipe is a socket; and
the front end of the nozzle is a split plug held in the socket of the pipe.

15. The swinging sprinkler with the driving device as claimed in claim 13, wherein
the connecting end of the pipe has an internal thread; and
the front end of the nozzle has an external thread engaging the internal thread of the pipe.
